(19) United States
(12) Patent Application Publication
(10) Pub. No.: US 2018/0252918 A1
(43) Pub. Date: Sep. 6, 2018

(54) Display Image Projection System

(71) Applicant: Yazaki Corporation, Tokyo (JP)

(72) Inventors: Nobuyuki Takahashi, Susono-shi (JP); Noriaki Narushima, Susono-shi (JP)

(73) Assignee: Yazaki Corporation, Tokyo (JP)

(21) Appl. No.: 15/911,605

(22) Filed: Mar. 5, 2018

(30) Foreign Application Priority Data
Mar. 6, 2017 (JP) 2017-041695

(51) Int. Cl. G02B 27/01; G02B 27/09

(52) U.S. Cl. CPC G02B 27/0101; B60K 2350/2052; G02B 2027/011; G02B 27/0983

(57) ABSTRACT

An aspherical mirror or a free-curved surface mirror is disposed inside an HUD unit, and the display light of a display device is emitted to the image projection area of the windshield of a vehicle. A distortion correction function for suppressing aberrations is provided on the reflecting surface of the free-curved surface mirror. A half mirror with a magnifying function configured as a Fresnel mirror is disposed in the image projection area of the windshield, whereby the half mirror with the magnifying function is provided with a magnifying function.

### CROSS REFERENCE TO RELATED APPLICATIONS

This application is based on and claims priority from Japanese patent application No. 2017-041695 filed on Mar. 6, 2017, the entire contents of which are incorporated herein by reference.

### BACKGROUND OF THE INVENTION

### 1. Technical Field

The present invention relates to a display image projection system capable of being mounted, for example, on a vehicle.

### 2. Background Art

For example, in the head-up display (HUD) apparatus disclosed in Patent Document JP-A-2004-226469, the display light emitted from an optical unit is projected to a predetermined display area on the surface of the front windshield on the inside of the compartment of a vehicle, part of the display light is reflected and guided to the eye point of the driver. Hence, the image generated by the display light is formed as a virtual image ahead of the front windshield, and the virtual image can be visually recognized by the driver. The optical unit is composed of a display device built in the housing thereof, a first reflecting mirror and a second reflecting mirror.

Furthermore, in Patent Document JP-A-2004-226469, the curvatures of the reflecting surfaces and the positional relationships of the plurality of reflecting mirrors provided in the optical system are specially devised to suppress image distortion occurring in the case that a display image is magnified.

### SUMMARY

However, in the case that an image is displayed by an HUD, aberrations occur, for example, under the influence due to the characteristics of the optical system of the HUD and due to the curved-surface shape of the windshield of a vehicle that is included in the optical path of the optical system. Hence, the aberrations are required to be corrected to obtain a clear display image, whereby such a technology as disclosed in Patent Document JP-A-2004-226469 is required. Furthermore, generally speaking, aberrations can be corrected by adopting a non-spherical lens or a non-spherical mirror having a free-curved surface as a component of the optical system.

On the other hand, in vehicles in recent years, the necessity for displaying a virtual image at a longer distance position from the viewpoint of the driver and the necessity for making the display screen for displaying a virtual image larger are intensified in the HUD. Hence, it is necessary to raise the magnification factor of an image by increasing the curvatures of the lenses and mirrors disposed in the optical system of the HUD, and it is also necessary to dispose a plurality of optical systems so as to be arranged in sequence.

However, in the case that the curvatures of the lenses and mirrors disposed in the optical system of the HUD are increased, the aberrations caused thereby are also increased, and the aberrations are required to be corrected. Furthermore, in the case that the curvatures of the lenses and mirrors are increased, the thicknesses and other dimensions of these optical components are increased, whereby the housing of the HUD unit for accommodating the optical system of the HUD is required to be made larger. However, it is difficult to securely obtain a space required for accommodating a large HUD unit in the vehicle.

Moreover, in the case that a virtual image display screen is made larger, the width of the optical path of the display light emitted from the HUD unit is required to be made larger, whereby the width of the light emitting port of the HUD unit is required to be widened and the opening of the dashboard of the vehicle is required to be made larger, resulting in the enlargement of the HUD unit. Hence, it is further difficult to mount the HUD unit in the vehicle.

The present invention has been made in consideration of the above-mentioned circumferences, and the object of the present invention is to provide a display image projection system capable of avoiding the enlargement of the housing even in the case that the virtual image display position is disposed at a long distance or the virtual image display screen is made larger.

To attain the above-mentioned object, a display image projection system according to the present invention is characterized as described in the following items (1) to (4).

(1) A display image projection system equipped with:

a display image projection unit having a housing, a display device accommodated in the housing, and a projection optical system accommodated in the housing and used to emit the display image of the display device in a predetermined direction and

an optically reflecting member disposed on the windshield of a vehicle or in the vicinity thereof and used to reflect at least part of the optical image emitted from the projection optical system and to guide the part to a predetermined eye point, wherein

the projection optical system has at least one aspherical mirror having a distortion correction function for correcting aberrations occurring in the optical paths from the display device to the eye point, and

the optically reflecting member has a Fresnel mirror, and the Fresnel mirror has an optically magnifying function for magnifying an image to be formed in the optical paths from the display device to the eye point.

(2) The display image projection system as set forth in the above-mentioned item (1), wherein

the optically reflecting member is disposed as an intermediate film among a plurality of glass layers constituting the windshield of the vehicle.

(3) The display image projection system as set forth in the above-mentioned item (1), wherein

the optically reflecting member is bonded to the surface of the windshield of the vehicle on the inside of the vehicle compartment by using a transparent material having a refractive index equivalent to that of the windshield.

(4) The display image projection system as set forth in the above-mentioned item (1), wherein

the optically reflecting member has a distortion correction function for correcting the aberrations occurring due to at least the curved-surface shape of the windshield.

With the display image projection system configured as described in the above-mentioned item (1), since the optically reflecting member on the outside of the display image projection unit has the optically magnifying function, the width of the optical path of the display light emitted from the display image projection unit to the optically reflecting member can be made smaller. Hence, the display image projection unit can be made more compact easily, and the dimensions of the opening of the dashboard can also be made smaller. Moreover, since the aspherical mirror has the distortion correction function, the occurrence of aberrations can be suppressed even in the case that the magnification factor of the optical system of the HUD is made larger.

With the display image projection system configured as described in the above-mentioned item (2), since the optically reflecting member is disposed on the inside of the windshield, the surface of the windshield can be maintained in a smooth state. Since the optically reflecting member is configured as the Fresnel mirror, the optically reflecting member has a planar shape and is disposed easily on the inside of the windshield.

With the display image projection system configured as described in the above-mentioned item (3), excessive refraction and reflection can be prevented from occurring at the boundary between the optically reflecting member and the surface of the windshield. What's more, since the optically reflecting member is configured as a Fresnel mirror, the optically reflecting member has a planar shape, and the unevenness formed on the windshield can be suppressed to the minimum.

With the display image projection system configured as described in the above-mentioned item (4), since each of the aspherical mirror of the projection optical system and the optically reflecting member has the distortion correction function, the aberrations of the entire system are suppressed easily. For example, the distortion due to the curved shape of the windshield can be corrected by the optically reflecting member, and the distortion due to the characteristics inside the projection optical system can be corrected by the aspherical mirror.

The present invention has been described above briefly. Moreover, the details of the present invention will be further clarified by reading the descriptions of the modes (hereafter referred to as “embodiments”) for embodying the invention to be described below referring to the accompanying drawings.

### BRIEF DESCRIPTION OF THE DRAWINGS

FIG. 1 is an optical path diagram showing a configuration of a display image projection system and the optical paths thereof according to an embodiment of the present invention as viewed from the side of a vehicle;

FIG. 2 is a front view showing the internal structure of the HUD unit shown in FIG. 1 and the optical paths thereof;

FIG. 3 is a perspective view showing an example of an external appearance of a free-curved surface mirror;

FIG. 4 is a cross-sectional view showing a configuration of a half mirror with a magnifying function built inside the windshield of the vehicle;

FIG. 5 is an optical path diagram showing the difference in the optical path depending on the presence/absence of the magnifying function in the half mirror with the magnifying function on the windshield of the vehicle;

FIG. 6 is a cross-sectional view showing Modification (1) of the mounting structure of the half mirror with the magnifying function;

FIG. 7 is a cross-sectional view showing Modification (2) of the mounting structure of the half mirror with the magnifying function;

FIG. 8 is a perspective view showing an external appearance of the half mirror with the magnifying function; and

FIG. 9A is a schematic view showing the planar shape, the cross-sectional shape in the thickness direction and the curvature distribution of the half mirror with the magnifying function on which a free-curved surface is formed, FIG. 9B is a cross-sectional view showing the cross-sectional shape at the section A in FIG. 9A, and FIG. 9C is a cross-sectional view showing the cross-sectional shape at the section B in FIG. 9A.

### DETAILED DESCRIPTION OF EMBODIMENTS

Specific embodiments according to the present invention will be described below referring to the accompanying drawings.

### First Embodiment

First, the outline of the configuration and operation will be described.

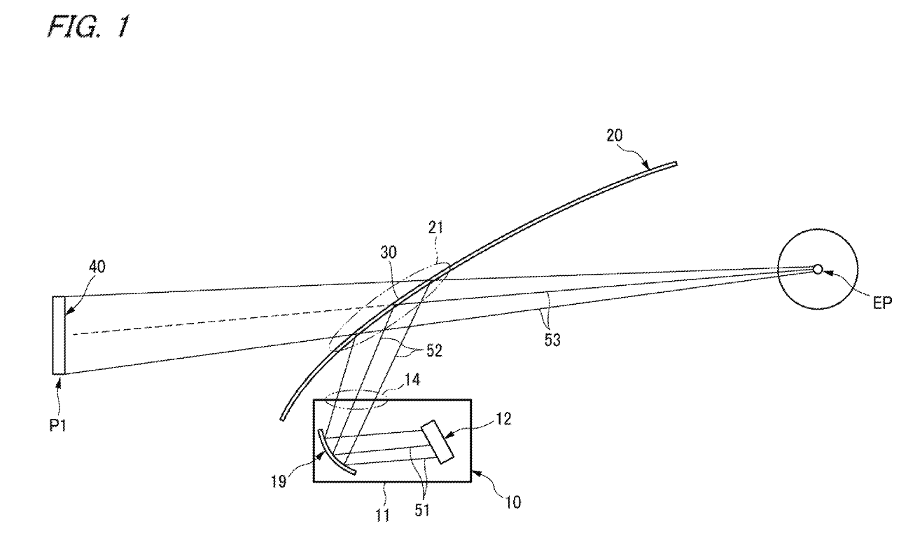

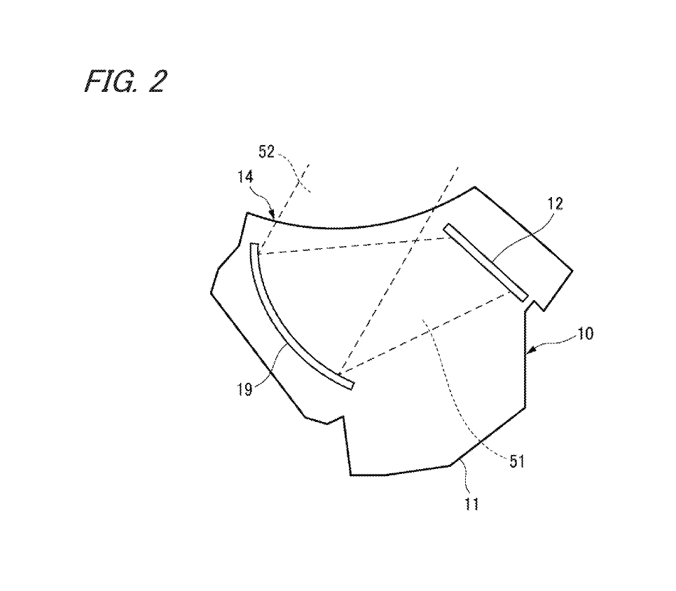

FIG. 1 shows the outline of a configuration of a display image projection system and the optical paths thereof according to an embodiment of the present invention as viewed from the side of a vehicle. Furthermore, FIG. 2 shows the internal structure of the HUD unit 10 shown in FIG. 1 and the optical paths thereof.

The display image projection system shown in FIG. 1 is intended to attain a head-up display (HUD) capable of being visually recognized by the driver on a vehicle. This display image projection system is equipped with an HUD unit 10 and a half mirror 30 with a magnifying function.

The HUD unit 10 is installed, for example, in a state of being fixed inside the dashboard ahead of the driver's seat of the vehicle. The display light emitted from the display light emitting section 14 of the HUD unit 10 passes through an optical path 52 via the opening of the dashboard and is guided to the image projection area 21 of the windshield (window glass) 20 of the vehicle provided upward.

In the example shown in FIG. 1, the half mirror 30 with the magnifying function is built in the image projection area 21 of the windshield 20. Part of the display light incident on the windshield 20 through the optical path 52 is reflected by the surface of the half mirror 30 with the magnifying function, passes through an optical path 53 and is directed to the eye point EP corresponding to the eye position of the driver.

Hence, in the case that the driver of the vehicle is looking toward the image projection area 21 of the windshield 20, he can visually recognize a virtual image 40 that is formed as if the image exists at a virtual image display position P1 ahead of the windshield 20. The visible information displayed as the virtual image 40 is the display image generated by the HUD unit 10 and is a visible image equivalent to the content displayed on the display screen of the display device 12 in the HUD unit 10.

Furthermore, since the half mirror 30 with the magnifying function transmits part of the light, when the driver is looking toward the image projection area 21, he can visually recognize, in addition to the virtual image 40, various scenes outside the vehicle in a state of being overlapped with the virtual image 40.

Since the half mirror 30 with the magnifying function in this embodiment has an optically magnifying function, the driver visually recognizes the virtual image 40 that is made larger than the optical image emitted from the HUD unit 10. Hence, the HUD display can be enlarged.

In the configuration shown in FIG. 2, the display device 12 and a free-curved surface mirror 19 are provided inside the housing 11 of the HUD unit 10. Instead of the free-curved surface mirror 19, an aspherical mirror having a general configuration may also be disposed.

The shape of the reflecting surface of a general aspherical mirror is, for example, such a curved surface as obtained by rotating a parabola around its axis, that is, a rotationally symmetrical curved surface. On the other hand, the shape of the reflecting surface of the free-curved surface mirror 19 is formed as a free-curved surface that is not rotationally symmetrical. Since the reflecting surfaces of the free-curved surface mirror 19 and the aspherical mirror do not have spherical surfaces, a distortion correction function can be provided for them. Furthermore, in the case of the free-curved surface mirror 19, distortion that is not rotationally symmetrical can also be corrected.

The display device 12 is configured, for example, as a liquid crystal display panel or an organic EL display panel having a two-dimensional display screen. Moreover, the display device 12 is equipped with an illumination function as in the case of a backlight. For this reason, the display device 12 can emit an optical image including the two-dimensional visible information displayed on its display screen.

The optical image emitted from the display device 12 passes through the optical path 51 and is incident on the surface of the free-curved surface mirror 19. The incident optical image is reflected by the surface of the free-curved surface mirror 19 and is emitted from the display light emitting section 14 of the HUD unit 10.

A turning back mirror, not shown, may be disposed in the optical path between the display device 12 and the free-curved surface mirror 19. The degree of freedom in the arrangement position of each of the display device 12 and the free-curved surface mirror 19 is enhanced by providing this kind of turning back mirror.

### <Explanation of Aberrations>

In the display image projection system shown in FIG. 1, however, various aberrations may occur. Due to these aberrations, color bleeding, blurring, distortion, etc. occur in the visible image that is visually recognized as the virtual image 40 by the driver. In reality, it is supposed that aberrations, such as the aberration occurring at each section of the optical system inside the HUD unit 10 and the aberration caused, for example, by the curved-surface shape of the reflecting surface of the windshield 20, may occur. Hence, it is necessary to avoid the occurrence of the above-mentioned aberrations so that the driver can visually recognize clear images.

In the HUD unit 10 shown in FIG. 2, the free-curved surface mirror 19 is equipped with a distortion correction function for avoiding the occurrence of the above-mentioned aberrations. Since the free-curved surface mirror 19 has a reflecting surface formed as a free-curved surface, the free-curved surface mirror 19 can correct distortions causing various aberrations by applying an appropriate curvature to each area of the reflecting surface.

Next, the free-curved surface mirror 19 will be described.

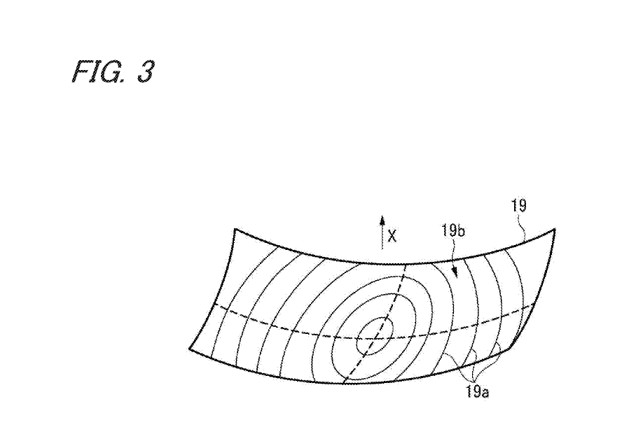

FIG. 3 shows an example an external appearance of the free-curved surface mirror 19.

In the free-curved surface mirror 19 shown in FIG. 3, a reflecting surface 19b having a free-curved surface shape is formed by bending a thin plate-shaped mirror material so as to be curved in the thickness direction (in the X direction). Furthermore, each of the contour lines 19a shown in FIG. 3 is a line obtained by connecting positions having an equal height in the thickness direction and is an imaginary line not visible in reality.

Since the reflecting surface 19b is curved, the respective contour lines 19a are formed such that a plurality of elliptical shapes is arranged coaxially as shown in FIG. 3. In reality, a predetermined free-curved surface can be formed by adjusting the curvature of each minute area of the reflecting surface 19b. Furthermore, aberrations can be corrected by disposing the free-curved surface in the optical path of an optical system, such as the HUD unit 10.

Next, the half mirror 30 with the magnifying function will be described in detail.

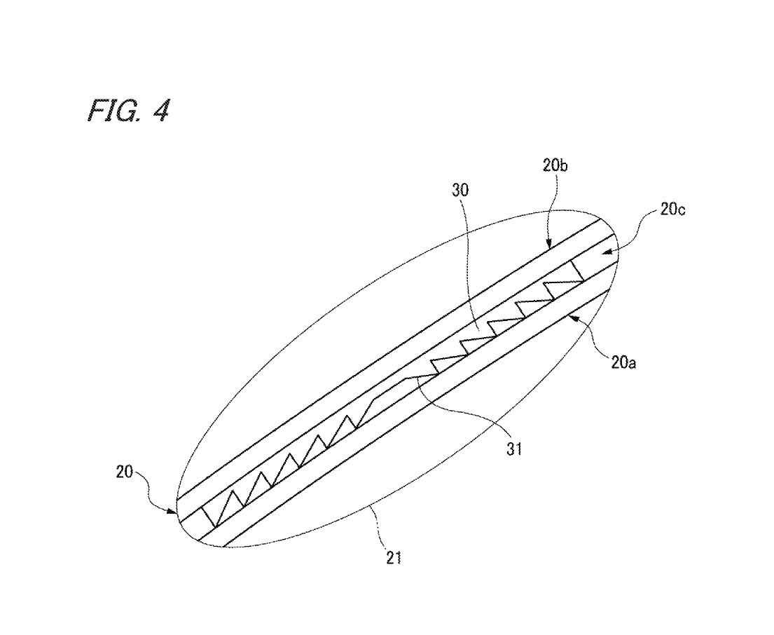

FIG. 4 shows a configuration example of the half mirror 30 with the magnifying function built inside the windshield 20 of the vehicle.

The half mirror 30 with the magnifying function shown in FIG. 4 is configured as a Fresnel mirror so as to be provided with an optically magnifying function. Since the half mirror 30 with the magnifying function is configured as a Fresnel mirror, the half mirror 30 is formed into a planar shape and can be built in the windshield 20 easily. Furthermore, also in the image projection area 21 of the windshield 20, the surface (the light reflecting surface 31) of the half mirror 30 with the magnifying function is configured as a half mirror so that the scenes outside the windshield 20 can be seen through the glass from the viewpoint of the driver.

In addition, although the Fresnel mirror of the half mirror 30 with the magnifying function has a function for optically magnifying a display image, the Fresnel mirror is not provided with a distortion correction function. Hence, it is not necessary to form a free-curved surface on the Fresnel mirror of the half mirror 30 with the magnifying function, whereby a Fresnel mirror having a general structure can be adopted. Moreover, transparent resin or glass is adopted as the main material constituting the half mirror 30 with the magnifying function so that the half mirror 30 functions as a half mirror.

In the example shown in FIG. 4, the windshield 20 of the vehicle is composed of two glass plates 20a and 20b and an intermediate film 20c being held therebetween. The half mirror 30 with the magnifying function is built inside the windshield 20 as part of the intermediate film 20c.

Since the half mirror 30 with the magnifying function is configured as a Fresnel mirror as described above, the half mirror 30 has a planar shape (flat plate shape) being thin in thickness and can be accommodated easily inside the windshield 20. Furthermore, the space between the light reflecting surface 31 of the half mirror 30 with the magnifying function and the glass plate 20a is filled with, for example, transparent resin having a refractive index equivalent to that of the glass plate 20a, thereby being sealed with the resin. This can prevent excessive reflection and refraction.

### <Influence Due to the Presence/Absence of the Magnifying Function on the Windshield 20>

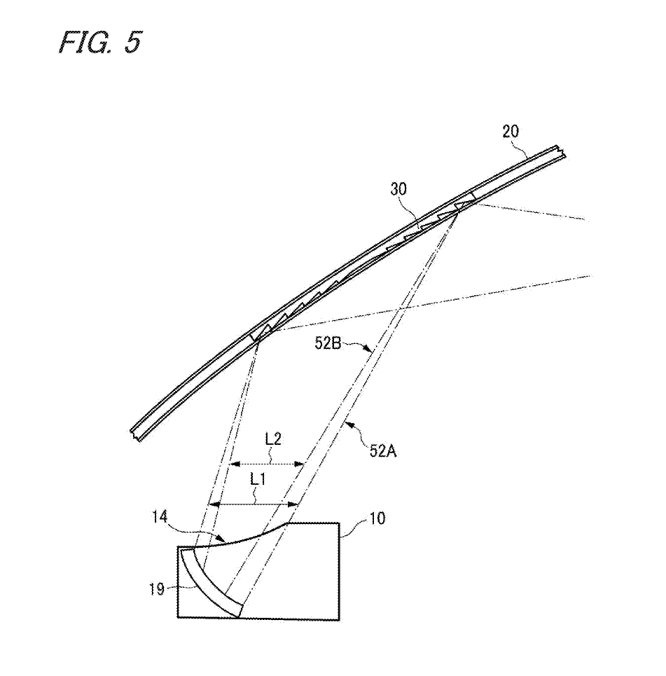

FIG. 5 shows the difference in the optical path depending on the presence/absence of the magnifying function in the half mirror 30 with the magnifying function on the windshield of the vehicle.

In the display image projection system shown in FIG. 1, under the condition that an image is formed as the virtual image 40 at the same position in the same size, such a difference as shown FIG. 5 is present between the optical path 52A in the case that the half mirror 30 with the magnifying function has no magnifying function and the optical path 52B in the case that the half mirror 30 with the magnifying function has the magnifying function. In other words, the relationship between the optical path width L1 of the optical path 52A and the optical path width L2 of the optical path 52B in the vicinity of the display light emitting section 14 of the HUD unit 10 becomes (L2<L1).

Hence, the opening of the dashboard corresponding to the display light emitting section 14, that is, the width of the opening, can be made smaller by providing the magnifying function of the half mirror 30 with the magnifying function on the windshield 20, whereby the housing 11 of the HUD unit 10 can be made more compact. Furthermore, since the effective areas required for the respective optical components inside the HUD unit 10 can be made smaller, the components can be made more compact and the housing 11 can also be made more compact.

<Modification (1) of the Half Mirror 30 with the Magnifying Function>

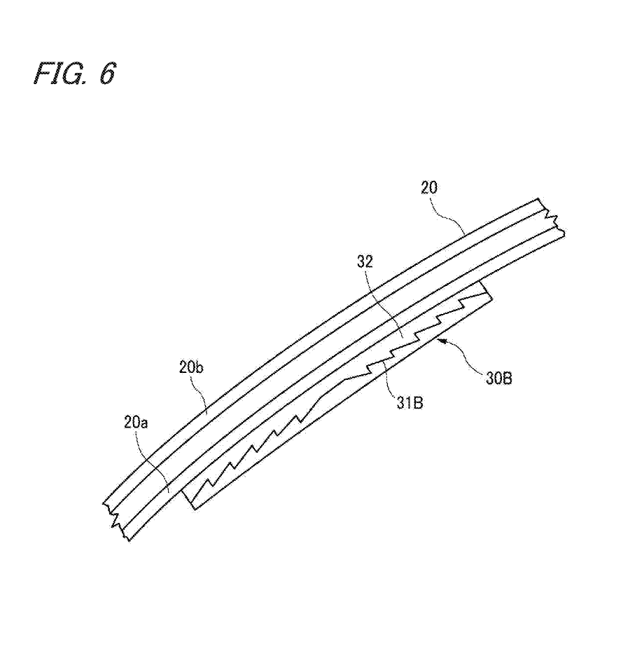

FIG. 6 shows Modification (1) of the mounting structure of the half mirror with the magnifying function.

The half mirror 30B with the magnifying function shown in FIG. 6 is different from the above-mentioned half mirror 30 with the magnifying function in the mounting structure on the windshield 20 although they are equivalent in shape and function.

More specifically, the half mirror 30B with the magnifying function shown in FIG. 6 is mounted in a state of being bonded to the surface of the glass plate 20a of the windshield 20 on the inside of the vehicle compartment. Furthermore, the half mirror 30B with the magnifying function is disposed in a state in which the Fresnel surface (reflecting surface 31B) thereof is opposed to the surface of the glass plate 20a. Moreover, the half mirror 30B with the magnifying function is bonded and fixed to the windshield 20 with the UV-hardened resin layer 32 formed between the Fresnel surface of the half mirror 30B and the glass plate 20a. The UV-hardened resin layer 32 is also filled in the concave sections in the Fresnel surface of the half mirror 30B with the magnifying function. Moreover, the UV-hardened resin layer 32 is made of a material having a refractive index equivalent to that of the glass plate 20a to prevent the occurrence of excessive refraction and reflection.

In the case that the mounting structure shown in FIG. 6 is adopted, after the manufacturing of the windshield 20, the half mirror 30B with the magnifying function can be bonded to the outside of the windshield as necessary, thereby being able to be mounted later.

<Modification (2) of the Half Mirror 30 with the Magnifying Function>

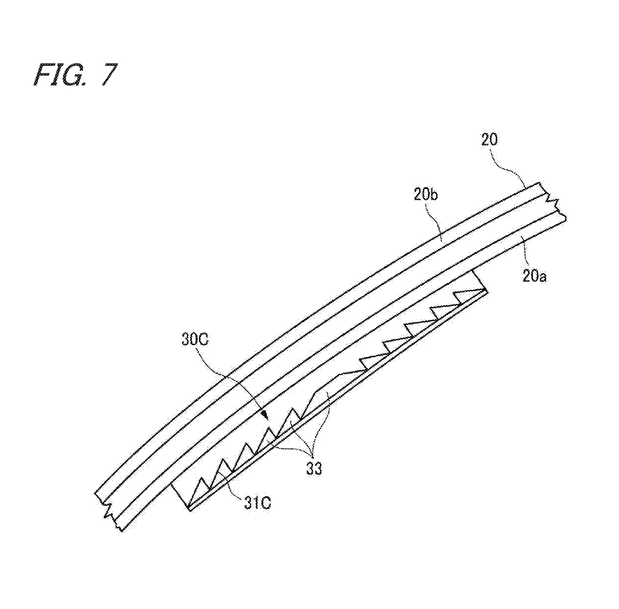

FIG. 7 shows Modification (2) of the mounting structure of the half mirror with the magnifying function.

The half mirror 30C with the magnifying function shown in FIG. 7 is different from the above-mentioned half mirror 30 with the magnifying function in the mounting structure on the windshield 20 although they are equivalent in shape and function.

More specifically, the half mirror 30C with the magnifying function shown in FIG. 7 is mounted in a state of being bonded to the surface of the glass plate 20a of the windshield 20 on the inside of the vehicle compartment. Furthermore, the half mirror 30C with the magnifying function is disposed in a state in which the surface (rear surface) thereof on the opposite side of the Fresnel surface (reflecting surface 31C) thereof is opposed to the surface of the glass plate 20a, and the rear face of the half mirror 30C with the magnifying function is bonded to the surface of the glass plate 20a by applying a transparent adhesive therebetween.

What's more, the surface of the half mirror 30C with the magnifying function including the concave sections of the Fresnel surface (reflecting surface 31C) is filled with transparent sealing resin 33, thereby being formed into a planar shape. Consequently, the convex and concave sections on the Fresnel surface are not exposed to the outside, thereby being able to be protected.

In the case that the mounting structure shown in FIG. 7 is adopted, after the manufacturing of the windshield 20, the half mirror 30C with the magnifying function can be bonded to the outside of the windshield as necessary, thereby being able to be mounted later.

### Second Embodiment

In the above-mentioned first embodiment, although the half mirror 30 with the magnifying function has the magnifying function, only the free-curved surface mirror 19 has the distortion correction function. In the second embodiment, a half mirror 30D with a magnifying function further provided with the distortion correction function is adopted instead of the half mirror 30 with the magnifying function. Moreover, since the half mirror 30D with the magnifying function is also provided with the distortion correction function in the second embodiment, the distortion correction amount in the free-curved surface mirror 19 can be made smaller than that in the first embodiment by the amount of the correction by the half mirror 30D. The configuration and operation other than those described above are similar to those in the first embodiment.

The half mirror 30D with the magnifying function is also desired to have a planar shape because the half mirror 30D is required to be mounted easily on the windshield 20. Hence, the half mirror 30D with the magnifying function in the second embodiment is configured as a free-curved surface Fresnel mirror.

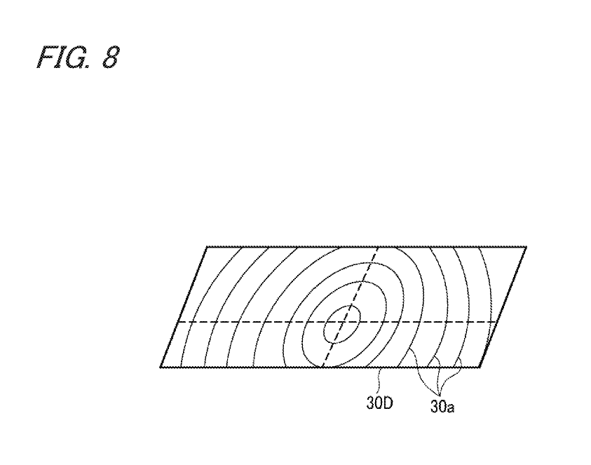

FIG. 8 shows an external appearance of the half mirror 30D with the magnifying function configured as a free-curved surface Fresnel mirror. As shown in FIG. 8, since the surface of the half mirror 30D with the magnifying function is not curved but is formed into a planar shape, the thickness dimension thereof is very small. Hence, the half mirror 30D with the magnifying function can be accommodated inside the windshield 20 or mounted on the surface thereof easily.

Furthermore, contour lines 30a similar to those on the surface of the free-curved surface mirror 19 shown in FIG. 3 are formed on the surface of the half mirror 30D with the magnifying function. The respective contour lines 30a on the half mirror 30D with the magnifying function can be seen actually as the lines obtained by connecting the top sections or the bottom sections of the concave/convex shapes formed on the surface of the half mirror 30D. Moreover, since the half mirror 30D with the magnifying function is not curved but is formed into a planar (flat plate) shape, the heights of the respective contour lines 303a are different from those of the contour lines 19a of the free-curved surface mirror 19.

In order that a free-curved surface functionally equivalent to that of the free-curved surface mirror 19 is formed on the surface of the half mirror 30D with the magnifying function, the free-curved surface intended to be obtained is divided into a plurality of areas, and the curved surfaces of the plurality of divided areas are arranged on a plane, whereby a Fresnel mirror is configured.

Next, a specific structure of the half mirror 30D with the magnifying function will be described.

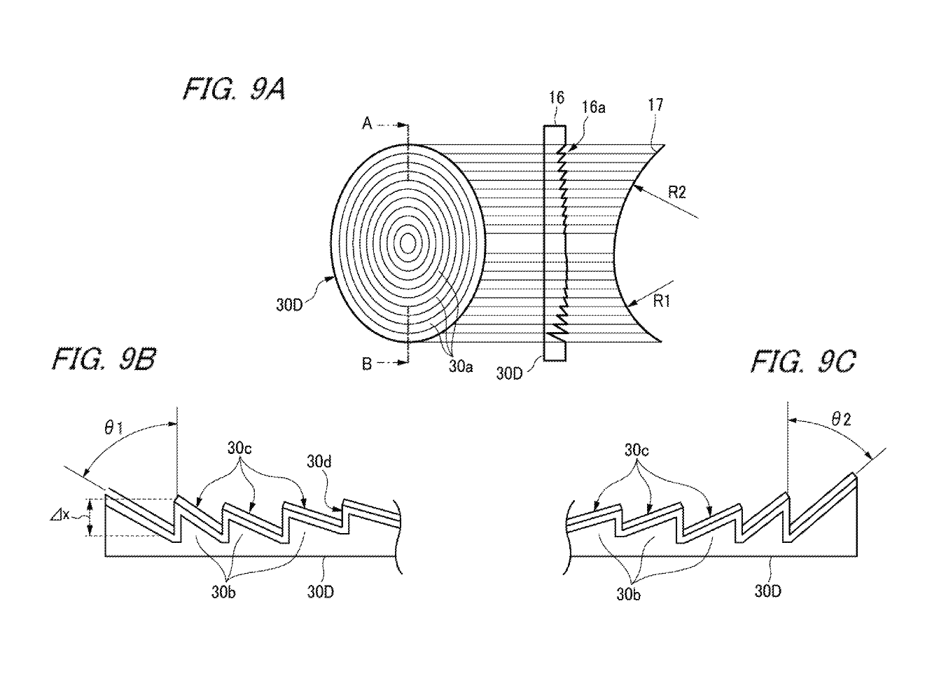

FIG. 9A shows the planar shape, the cross-sectional shape in the thickness direction and the curvature distribution of the half mirror 30D with the magnifying function on which a free-curved surface is formed, and FIGS. 9B and 9C show the cross-sectional shapes at the section A and the section B in FIG. 9A, respectively.

As in the flat surface shape 15 shown in FIG. 9A, patterns resembling a plurality of coaxial circles or ellipses, similar to the contour lines 30a shown in FIG. 8, appear on the surface (the Fresnel surface) of the half mirror 30D with the magnifying function. These patterns correspond to such sawtooth-shaped concave sections 16a as appearing in the cross-sectional shape 16 in the thickness direction shown in FIG. 9A.

In reality, as shown in FIGS. 9B and 9C, a minute prism section 30b is formed between the contour lines 30a being adjacent to each other. Furthermore, each prism section 30b has an inclined face 30c and a vertical wall 30d extending in the thickness direction.

The shape and characteristics of each prism section 30b forming the free-curved surface can be specified by the inclination angle (θ1, θ2, etc.) of the inclined face 30c and the height (the depth of the concave section: the amount of sag Δx) of the vertical wall 30d.

In the half mirror 30D with the magnifying function shown in FIGS. 9A, 9B and 9C, the Fresnel surface is formed so as to conform to the conditions of “Specification 1” described below. However, “Specification 2” may be adopted instead of “Specification 1”.

### <“Specification 1” of the Fresnel Surface Shape>

(1) On the Fresnel surface, the height (Δx) of the vertical wall 30d is not uniform but changes for each area.

(2) Around one circumference in the circumferential direction of a single elliptical contour line 30a, the height (Δx) of the vertical wall 30d is constant.

(3) On the Fresnel surface, the inclination angle (θ1, θ2, etc.) of the inclined face 30c changes continuously depending on the difference in the position in the circumferential direction. For example, the inclination angle (θ1) of the outermost circumferential prism section 30b at the position shown in FIG. 9B is not the same as the inclination angle (θ2) at the position shown in FIG. 9C.

### <“Specification 2” of the Fresnel Surface Shape>

(1) On the Fresnel surface, the height (Δx) of the vertical wall 30d is not uniform but changes for each area.

(2B) In each prism section 30b on the Fresnel surface, the height (Δx) of the vertical wall 30d changes continuously depending on the difference in the position in the circumferential direction.

(3B) In each prism section 30b on the Fresnel surface, the inclination angle of the inclined face 30c is constant around one circumference in the circumferential direction of a single elliptical contour line 30a.

In the case that the Fresnel surface is formed according to the conditions of the above-mentioned “Specification 1” or “Specification 2”, it is possible to configure the half mirror 30D with the magnifying function as a free-curved surface Fresnel mirror capable of performing a function optically equivalent to that of the free-curved surface. For example, the curvature and the curvature radius (R1, R2) changes depending on the position as in the curvature distribution shown in FIG. 9A. Hence, the half mirror 30D with the magnifying function can be provided with the distortion correction function for suppressing the occurrence of the aberrations. Moreover, since the half mirror 30D with the magnifying function has a free-curved surface, the half mirror 30D can also correct distortions asymmetrical with respect to a specific axis.

Since the half mirror 30 with the magnifying function has the optically magnifying function in both the first embodiment and the second embodiment described above, the optical path width L2 in the vicinity of the display light emitting section 14 becomes smaller as shown in FIG. 5. Hence, the HUD unit 10 can be made more compact, and the optical components inside the HUD unit can also be made more compact. Furthermore, the opening of the dashboard can be made smaller. Moreover, since the free-curved surface mirror 19 in the HUD unit 10 has the distortion correction function, for example, even in the case that the windshield 20 having a curved-surface shape is used as the image projection area 21 or the virtual image 40 is displayed on a large screen, a clear display image can be formed. What's more, since the half mirror 30 with the magnifying function is configured as a Fresnel mirror having a planar shape, the half mirror 30 can be mounted easily on the windshield 20, and the unevenness on the surface of the windshield can be suppressed to the minimum.

Still further, in the case that the half mirror 30 with the magnifying function having the distortion correction function is mounted on the windshield 20, even in the case that the surface shape of the windshield 20 changes, for example, depending on the difference in vehicle type, the distortion of the image due to the shape can be corrected by using only the half mirror 30D with the magnifying function. For this reason, the correction amount of the free-curved surface mirror 19 is not required to be changed even if the type of the vehicle changes.

With the display image projection system according to the present invention, even in the case that the virtual image display position is disposed at a long distance or the virtual image display screen is made larger, the housing of the display image projection unit can be avoided from becoming larger. In other words, since the optically reflecting member on the outside of the display image projection unit has the optically magnifying function, the width of the optical path of the display light emitted from the display image projection unit to the optically reflecting member can be made smaller, the display image projection unit can be made more compact easily, and the dimensions of the opening of the dashboard can also be made smaller. Moreover, since the aspherical mirror has the distortion correction function, the occurrence of aberrations can be suppressed even in the case that the magnification factor of the optical system of the HUD is made larger.

The characteristics of the embodiments of the display image projection system according to the present invention described above will be briefly summarized and listed in the following items [1] to [4].

[1] A display image projection system equipped with:

a display image projection unit (an HUD unit 10) having a housing (11), a display device (12) accommodated in the housing, and a projection optical system accommodated in the housing and used to emit the display image of the display device in a predetermined direction and

an optically reflecting member (a half mirror 30 with a magnifying function) disposed on the windshield (20) of a vehicle or in the vicinity thereof and used to reflect at least part of the optical image emitted from the projection optical system and to guide the part to a predetermined eye point, wherein

the projection optical system has at least one aspherical mirror (a free-curved surface mirror 19) having a distortion correction function for correcting aberrations occurring in the optical paths from the display device to the eye point, and

the optically reflecting member has a Fresnel mirror, and the Fresnel mirror has an optically magnifying function for magnifying an image to be formed in the optical paths from the display device to the eye point.

[2] The display image projection system as set forth in the above-mentioned item [1], wherein

the optically reflecting member (the half mirror 30 with the magnifying function) is disposed as an intermediate film among a plurality of glass layers constituting the windshield of the vehicle (see FIG. 4).

[3] The display image projection system as set forth in the above-mentioned item [1], wherein

the optically reflecting member (the half mirror 30B, 30C with the magnifying function) is bonded to the surface of the windshield of the vehicle on the inside of the vehicle compartment by using a transparent material having a refractive index equivalent to that of the windshield (see FIGS. 6 and 7).

[4] The display image projection system as set forth in the above-mentioned item [1], wherein

the optically reflecting member (the half mirror 30D with the magnifying function) has a distortion correction function for correcting the aberrations occurring due to at least the curved-surface shape of the windshield.

What is claimed is:

1. A display image projection system equipped with:
a display image projection unit having a housing, a display device accommodated in the housing, and a projection optical system accommodated in the housing and used to emit the display image of the display device in a predetermined direction and
an optically reflecting member disposed on the windshield of a vehicle or in the vicinity thereof and used to reflect at least part of the optical image emitted from the projection optical system and to guide the part to a predetermined eye point, wherein
the projection optical system has at least one aspherical mirror having a distortion correction function for correcting aberrations occurring in the optical paths from the display device to the eye point, and
the optically reflecting member has a Fresnel mirror, and the Fresnel mirror has an optically magnifying function for magnifying an image to be formed in the optical paths from the display device to the eye point.

2. The display image projection system as set forth in claim 1, wherein
the optically reflecting member is disposed as an intermediate film among a plurality of glass layers constituting the windshield of the vehicle.

3. The display image projection system as set forth in claim 1, wherein
the optically reflecting member is bonded to the surface of the windshield of the vehicle on the inside of the vehicle compartment by using a transparent material having a refractive index equivalent to that of the windshield.

4. The display image projection system as set forth in claim 1, wherein
the optically reflecting member has a distortion correction function for correcting the aberrations occurring due to at least the curved-surface shape of the windshield.
